(19) United States
(12) Patent Application Publication
(10) Pub. No.: US 2022/0321999 A1
(43) Pub. Date: Oct. 6, 2022

(54) MINIATURE HIGH PERFORMANCE MEMS PIEZOELECTRIC TRANSDUCER

(71) Applicant: Facebook Technologies, LLC, Menlo Park, CA (US)

(72) Inventors: Chuming Zhao, Redmond, WA (US); John Raymond Brodie, Bend, OR (US); Rex Pinegar Price, San Jose, CA (US); Michael Smedegaard, Bellevue, WA (US); Antonio John Miller, Woodinville, WA (US); Tetsuro Oishi, Bothell, WA (US)

(21) Appl. No.: 17/677,513

(22) Filed: Feb. 22, 2022

Related U.S. Application Data
(60) Provisional application No. 63/169,074, filed on Mar. 31, 2021.

(51) Int. Cl. H04R 1/40; H04R 17/00; H04R 1/10; H04R 1/02; H04R 7/06; H04R 3/12

(52) U.S. Cl. CPC H04R 1/403; H04R 17/00; H04R 1/1008; H04R 1/028; H04R 7/06; H04R 3/12; H04R 2400/11; H04R 2499/15

(57) ABSTRACT

A dipole speaker assembly comprises a transducer section, a front volume section, and a rear volume section. The transducer section includes a frame and piezoelectric actuators coupled to the frame. The piezoelectric actuators are configured to generate an acoustic pressure wave. The transducer section includes a first side and a second side, the second side being opposite the first side. The front volume section is coupled to the first side to form a front cavity, the front volume section including an aperture from which the generated acoustic pressure wave exits the front volume section towards an ear canal of a user. The rear volume section is coupled to the second side to form a rear cavity. The generated acoustic pressure wave exiting the rear volume section cancels the generated acoustic pressure wave exiting the front volume section in the far field.

### CROSS REFERENCE TO RELATED APPLICATIONS

This application is claims priority to pending U.S. Application No. 63/169,074, filed Mar. 31, 2021, which is incorporated by reference in its entirety.

### FIELD OF THE INVENTION

This disclosure relates generally to piezoelectric speakers, and more specifically to miniature high performance micro-electromechanical systems (MEMS) piezoelectric transducers.

### BACKGROUND

Speakers can be integrated into the frame of a headset to provide audio content to a user. However, the headset form factor (especially something like stylish eye glasses) has challenging size and weight constraints that make it very difficult to fit speakers within the frame of the headset. Moreover, traditional dynamic loudspeakers (e.g., with magnet and coil) may be limited in miniaturization.

### SUMMARY

A speaker package is integrated into a headset. The speaker package comprises multiple transducer layers. Each transducer layer comprises at least one piezoelectric actuator. The piezoelectric actuators may be displaced to generate acoustic pressure waves which are directed to the ear of the user of the headset. The small size of the speaker package allows the speaker package to be located within a small component, such as within a temple arm of a headset. However, despite the small size of the speaker package, the speaker design provides large volume displacement and high output power, such that high quality audio content may be provided to a wearer of the headset. In some embodiments, the speaker package may operate as a dipole speaker that cancels sound in the far field.

In some embodiments, a dipole speaker assembly may comprise a first transducer section including a frame and a first piezoelectric actuator coupled to the frame. The dipole speaker assembly may comprise a second transducer section including a second frame and a second piezoelectric actuator coupled to the second frame. A front volume section may be positioned between the first transducer section and the second transducer section to form a front cavity from which a generated acoustic pressure wave exits the front volume section towards an ear canal of a user. A first rear volume section may be coupled to the first transducer section and a second rear volume section may be coupled to the second transducer section, from which the generated acoustic pressure wave exits the rear volume sections away from the ear canal of the user.

In some embodiments, a headset may comprise a front portion comprising a display element, a temple section coupled to the front portion, and a speaker package located within the temple section. The speaker package may comprise a first transducer section including a frame and a first piezoelectric actuator coupled to the frame. The speaker package may comprise a second transducer section including a second frame and a second piezoelectric actuator coupled to the second frame. A front volume section may be positioned between the first transducer section and the second transducer section to form a front cavity from which a generated acoustic pressure wave exits the front volume section towards an ear canal of a user. A first rear volume section may be coupled to the first transducer section and a second rear volume section may be coupled to the second transducer section, from which the generated acoustic pressure wave exits the rear volume sections away from the ear canal of the user.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2 is a block diagram of an audio system, in accordance with one or more embodiments.

FIG. 3 is an example of an isometric view of a speaker, in accordance with one or more embodiments.

FIG. 4 is an example of an isometric view of a speaker with split piezoelectric actuators, in accordance with one or more embodiments.

FIG. 5 is an example of an isometric view of a speaker with continuous actuators displaced, in accordance with one or more embodiments.

FIG. 6 is an example of an isometric view of a speaker with actuators having a fixed end and a free end, in accordance with one or more embodiments.

FIG. 7 is an example of an exploded view of a speaker package having two transducer sections, in accordance with one or more embodiments.

FIG. 8A is an example of a cross sectional view of a speaker with two piezoelectric layers, in accordance with one or more embodiments.

FIG. 8B is an example of a cross sectional view of a speaker with a single piezoelectric layer, in accordance with one or more embodiments.

FIG. 9 is an example of a cross sectional view of a speaker package with two piezoelectric layers, in accordance with one or more embodiments.

FIG. 10 is an example of a cross sectional view of a speaker package with four piezoelectric layers, in accordance with one or more embodiments.

FIG. 11 is an example of a cross sectional view of a speaker package with offset piezoelectric layers, in accordance with one or more embodiments.

FIG. 12 is a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments relate to a headset having integrated speaker packages with piezoelectric actuators to provide sound to a user. The speaker package includes a front volume section, one or more transducer sections including the piezoelectric actuators, and one or more rear volume sections. The front volume section, the one or more transducer sections, and the one or more rear volume sections are attached together to form a speaker package that may be integrated into the form factor of the headset.

Advantages of the disclosed speaker packages over a conventional dynamic loudspeaker can include a reduction in size, a reduction in weight, an improvement in power efficiency, an improvement in impulse response, an improvement in durability, an improvement in water resistance, and an ability to provide full band audio content. The speaker package with piezoelectric actuators eliminates the use of magnets and a coil of a conventional dynamic loudspeaker, allowing for the reduction in size, reduction in weight, an improvement in water resistance, and improvement in power efficiency. In contrast to a conventional loudspeaker that is round in shape, the piezoelectric actuators of the speaker package can be customized into any desired shape. In this case, it has a high aspect ratio which enable a shape of the speaker package device to better fit inside the form factor of the headset, which may include temple sections having a long and narrow shape. The high aspect ratio of the piezoelectric actuators can be selected to move a resonance frequency of the piezoelectric actuators outside of a main band of human hearing so that the piezoelectric actuators can provide a flat response in the full band audio content. In contrast, a conventional loudspeaker has a resonance within the audio band (20 Hz-20 k Hz) which results in a non-flat response. If needed, the resonance may also be placed within the audio band. Sometimes, two or more speakers are used to cover the full audio band, one to provide for lower frequencies and one to provide for higher frequencies in the main band of human hearing. Multiple speaker packages may be used in the headset for beamsteering to direct audio content to the ear of the user. Additionally, multiple speaker packages may be used to cancel audio content in the far field. The speaker package may be fabricated using a micro-electro-mechanical system (MEMS) process technology to enable a reduction in size, and the use of piezoelectric ceramic may enable improvements in durability. Use of MEMS process technology has advantages in manufacturing such as high precision and high repeatability. The use of piezoelectric ceramic as the active moving element has the material strength advantage over the traditional diaphragm, which often is plastic. Moreover, the piezoelectric ceramic responds more linearly than traditional speakers. Therefore, this device is more durable and more linear, compared to the traditional speakers. The piezoelectric actuators may be cantilever bimorphs or unimorphs with low mass and high stiffness, which as the active moving element, improves the impulse response of the piezoelectric actuators to provide higher performance active noise control over a conventional dynamic loudspeaker.

The term MEMS process technology refers to a process technology used to manufacture devices that include mechanical and electrical components that can be micrometers in size. MEMS process technology may be silicon-based, and produced using microfabrication processes developed for integrated circuits (ICs). The devices manufactured by MEMS process technology may be 3D structures which involve mechanical movement of components.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

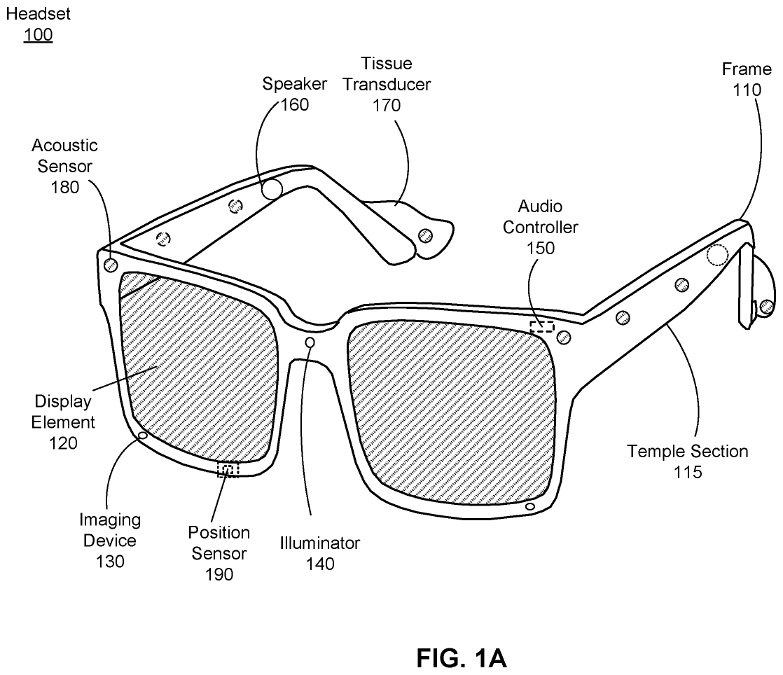

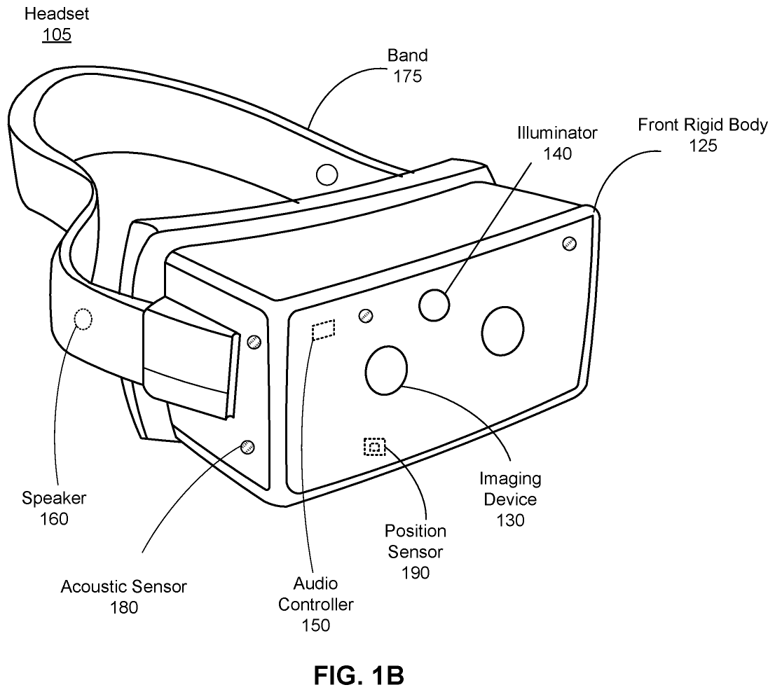

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1A.

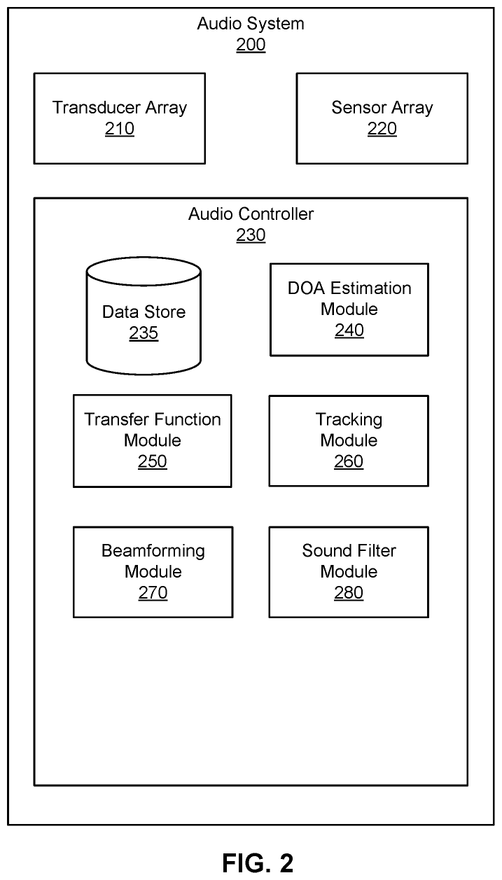

One or more speakers 160 may be integrated into the temple section 115 of the frame 110. The speakers 160 may form a portion of the surface of the temple section 115. In some embodiments, the speakers 160 may be located within the temple section 115, and the temple section 115 may comprise one or more apertures that allow sound waves to travel from the speakers 160 to the ear canal of the user. The speakers 160 may comprise piezoelectric membranes. The speakers 160 may be part of a speaker package that includes a front volume section, one or more transducer sections including the piezoelectric actuators, and one or more rear volume sections. The front volume section, the one or more transducer sections, and the one or more rear volume sections are attached together to form a speaker package that may be integrated into the form factor of the headset. The speakers 160 may be arranged in a dipole configuration. An acoustic pressure wave may exit the front volume section in the direction of an ear of the user. An acoustic pressure wave may exit the rear volume section into the local area. The acoustic pressure wave exiting the rear volume section may cancel the acoustic pressure wave exiting the front volume section in the far field. The speaker configurations are further described with respect to FIGS. 2-10.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIGS. 2-10.

FIG. 1B is a perspective view of a headset 105 implemented as a HMD, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A, but modified to integrate with the HMD form factor. For example, the HMD includes a display assembly, a DCA, an audio system, and a position sensor 190. FIG. 1B shows the illuminator 140, a plurality of the speakers 160, a plurality of the imaging devices 130, a plurality of acoustic sensors 180, and the position sensor 190.

The speakers 160 may be located in various locations, such as coupled to the band 175 (as shown), coupled to front rigid body 115, or may be configured to be inserted within the ear canal of a user. The speakers 160 may comprise piezoelectric transducers in a speaker package that is integrated into the band 175. The speakers 160 may be configured in a dipole configuration, such that, in the far field, acoustic pressure waves transmitted into the local area cancel acoustic pressure waves transmitted toward the ear of the user. Multiple speakers 160 may be configured to beamsteer acoustic pressure waves toward the ear of the user.

FIG. 2 is a block diagram of an audio system 200, in accordance with one or more embodiments. The audio system in FIG. 1A or FIG. 1B may be an embodiment of the audio system 200. The audio system 200 generates one or more acoustic transfer functions for a user. The audio system 200 may then use the one or more acoustic transfer functions to generate audio content for the user. In the embodiment of FIG. 2, the audio system 200 includes a transducer array 210, a sensor array 220, and an audio controller 230. Some embodiments of the audio system 200 have different components than those described here. Similarly, in some cases, functions can be distributed among the components in a different manner than is described here.

The transducer array 210 is configured to present audio content. The transducer array 210 includes a plurality of transducers. A transducer is a device that provides audio content. A transducer may be, e.g., a speaker (e.g., the speaker 160), a tissue transducer (e.g., the tissue transducer 170), some other device that provides audio content, or some combination thereof. A tissue transducer may be configured to function as a bone conduction transducer or a cartilage conduction transducer. The transducer array 210 may present audio content via air conduction (e.g., via one or more speakers), via bone conduction (via one or more bone conduction transducer), via cartilage conduction audio system (via one or more cartilage conduction transducers), or some combination thereof. In some embodiments, the transducer array 210 may include one or more transducers to cover different parts of a frequency range. For example, a piezoelectric transducer may be used to cover a first part of a frequency range and a moving coil transducer may be used to cover a second part of a frequency range.

The transducer array 210 may comprise one or more speaker packages integrated into the headset. A speaker package comprises a frame and a plurality of transducer sections in a stacked arrangement. Each transducer section is adjacent to a front volume section and a rear volume section. Adjacent transducer sections may use the same front volume section or rear volume section. The speaker package is manufactured using a MEMS process. The speaker package is small relative to conventional speakers. For example, in some embodiments, the speaker package may be less than 10 mm long×5 mm wide×5 mm high and weigh less than 0.5 grams.

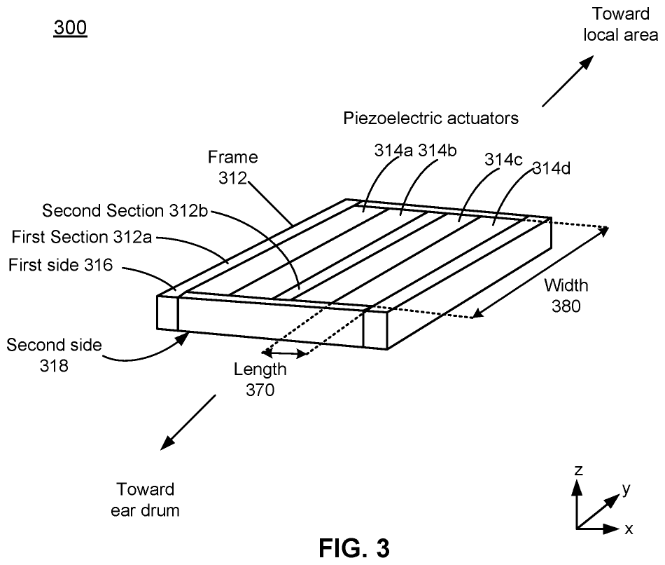

A transducer section of the speaker package comprises a frame and one or more piezoelectric actuators. Each piezoelectric actuator may comprise at least one fixed end coupled to the frame. In some embodiments, the piezoelectric actuators comprise a free end configured to move in response to a voltage applied to the piezoelectric actuator. A maximum displacement of the piezoelectric actuator may be at the free end. In some embodiments, the piezo electric actuators comprised two fixed ends. A maximum displacement of the piezoelectric actuator may be along the center of the piezoelectric actuator between the two fixed ends. In some embodiments, a maximum excursion of each piezoelectric actuator may be between 10 microns-50 microns. As a reference, conventional MEMS speakers may only be only a few microns. The total volume displacement of the speaker package may be between 1-5×10⁻⁹ cubic meters. The speaker package may output at least 60 dB SPL at 500 Hz. The speaker packages are further described with respect to FIG. 3-10.

The bone conduction transducers generate acoustic pressure waves by vibrating bone/tissue in the user's head. A bone conduction transducer may be coupled to a portion of a headset, and may be configured to be behind the auricle coupled to a portion of the user's skull. The bone conduction transducer receives vibration instructions from the audio controller 230, and vibrates a portion of the user's skull based on the received instructions. The vibrations from the bone conduction transducer generate a tissue-borne acoustic pressure wave that propagates toward the user's cochlea, bypassing the eardrum.

The cartilage conduction transducers generate acoustic pressure waves by vibrating one or more portions of the auricular cartilage of the ears of the user. A cartilage conduction transducer may be coupled to a portion of a headset, and may be configured to be coupled to one or more portions of the auricular cartilage of the ear. For example, the cartilage conduction transducer may couple to the back of an auricle of the ear of the user. The cartilage conduction transducer may be located anywhere along the auricular cartilage around the outer ear (e.g., the pinna, the tragus, some other portion of the auricular cartilage, or some combination thereof). Vibrating the one or more portions of auricular cartilage may generate: airborne acoustic pressure waves outside the ear canal; tissue born acoustic pressure waves that cause some portions of the ear canal to vibrate thereby generating an airborne acoustic pressure wave within the ear canal; or some combination thereof. The generated airborne acoustic pressure waves propagate down the ear canal toward the ear drum.

The transducer array 210 generates audio content in accordance with instructions from the audio controller 230. In some embodiments, the audio content is spatialized. Spatialized audio content is audio content that appears to originate from a particular direction and/or target region (e.g., an object in the local area and/or a virtual object). For example, spatialized audio content can make it appear that sound is originating from a virtual singer across a room from a user of the audio system 200. The transducer array 210 may be coupled to a wearable device (e.g., the headset 100 or the headset 105). In alternate embodiments, the transducer array 210 may be a plurality of speakers that are separate from the wearable device (e.g., coupled to an external console).

The sensor array 220 detects sounds within a local area surrounding the sensor array 220. The sensor array 220 may include a plurality of acoustic sensors that each detect air pressure variations of a sound wave and convert the detected sounds into an electronic format (analog or digital). The plurality of acoustic sensors may be positioned on a headset (e.g., headset 100 and/or the headset 105), on a user (e.g., in an ear canal of the user), on a neckband, or some combination thereof. An acoustic sensor may be, e.g., a microphone, a vibration sensor, an accelerometer, or any combination thereof. In some embodiments, the acoustic microphone may comprise a plurality of piezoelectric actuators in a microphone package, similar to the speaker packages described with reference to speakers 160. In some embodiments, the sensor array 220 is configured to monitor the audio content generated by the transducer array 210 using at least some of the plurality of acoustic sensors. Increasing the number of sensors may improve the accuracy of information (e.g., directionality) describing a sound field produced by the transducer array 210 and/or sound from the local area.

The audio controller 230 controls operation of the audio system 200. In the embodiment of FIG. 2, the audio controller 230 includes a data store 235, a DOA estimation module 240, a transfer function module 250, a tracking module 260, a beamforming module 270, and a sound filter module 280. The audio controller 230 may be located inside a headset, in some embodiments. Some embodiments of the audio controller 230 have different components than those described here. Similarly, functions can be distributed among the components in different manners than described here. For example, some functions of the controller may be performed external to the headset. The user may opt in to allow the audio controller 230 to transmit data captured by the headset to systems external to the headset, and the user may select privacy settings controlling access to any such data.

The data store 235 stores data for use by the audio system 200. Data in the data store 235 may include sounds recorded in the local area of the audio system 200, audio content, head-related transfer functions (HRTFs), transfer functions for one or more sensors, array transfer functions (ATFs) for one or more of the acoustic sensors, sound source locations, virtual model of local area, direction of arrival estimates, sound filters, and other data relevant for use by the audio system 200, or any combination thereof.

The DOA estimation module 240 is configured to localize sound sources in the local area based in part on information from the sensor array 220. Localization is a process of determining where sound sources are located relative to the user of the audio system 200. The DOA estimation module 240 performs a DOA analysis to localize one or more sound sources within the local area. The DOA analysis may include analyzing the intensity, spectra, and/or arrival time of each sound at the sensor array 220 to determine the direction from which the sounds originated. In some cases, the DOA analysis may include any suitable algorithm for analyzing a surrounding acoustic environment in which the audio system 200 is located.

For example, the DOA analysis may be designed to receive input signals from the sensor array 220 and apply digital signal processing algorithms to the input signals to estimate a direction of arrival. These algorithms may include, for example, delay and sum algorithms where the input signal is sampled, and the resulting weighted and delayed versions of the sampled signal are averaged together to determine a DOA. A least mean squared (LMS) algorithm may also be implemented to create an adaptive filter. This adaptive filter may then be used to identify differences in signal intensity, for example, or differences in time of arrival. These differences may then be used to estimate the DOA. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct path audio signal. Those bins having a portion of the direct-path signal may then be analyzed to identify the angle at which the sensor array 220 received the direct-path audio signal. The determined angle may then be used to identify the DOA for the received input signal. Other algorithms not listed above may also be used alone or in combination with the above algorithms to determine DOA.

In some embodiments, the DOA estimation module 240 may also determine the DOA with respect to an absolute position of the audio system 200 within the local area. The position of the sensor array 220 may be received from an external system (e.g., some other component of a headset, an artificial reality console, a mapping server, a position sensor (e.g., the position sensor 190), etc.). The external system may create a virtual model of the local area, in which the local area and the position of the audio system 200 are mapped. The received position information may include a location and/or an orientation of some or all of the audio system 200 (e.g., of the sensor array 220). The DOA estimation module 240 may update the estimated DOA based on the received position information.

The transfer function module 250 is configured to generate one or more acoustic transfer functions. Generally, a transfer function is a mathematical function giving a corresponding output value for each possible input value. Based on parameters of the detected sounds, the transfer function module 250 generates one or more acoustic transfer functions associated with the audio system. The acoustic transfer functions may be array transfer functions (ATFs), head-related transfer functions (HRTFs), other types of acoustic transfer functions, or some combination thereof. An ATF characterizes how the microphone receives a sound from a point in space.

An ATF includes a number of transfer functions that characterize a relationship between the sound source and the corresponding sound received by the acoustic sensors in the sensor array 220. Accordingly, for a sound source there is a corresponding transfer function for each of the acoustic sensors in the sensor array 220. And collectively the set of transfer functions is referred to as an ATF. Accordingly, for each sound source there is a corresponding ATF. Note that the sound source may be, e.g., someone or something generating sound in the local area, the user, or one or more transducers of the transducer array 210. The ATF for a particular sound source location relative to the sensor array 220 may differ from user to user due to a person's anatomy (e.g., ear shape, shoulders, etc.) that affects the sound as it travels to the person's ears. Accordingly, the ATFs of the sensor array 220 are personalized for each user of the audio system 200.

In some embodiments, the transfer function module 250 determines one or more HRTFs for a user of the audio system 200. The HRTF characterizes how an ear receives a sound from a point in space. The HRTF for a particular source location relative to a person is unique to each ear of the person (and is unique to the person) due to the person's anatomy (e.g., ear shape, shoulders, etc.) that affects the sound as it travels to the person's ears. In some embodiments, the transfer function module 250 may determine HRTFs for the user using a calibration process. In some embodiments, the transfer function module 250 may provide information about the user to a remote system. The user may adjust privacy settings to allow or prevent the transfer function module 250 from providing the information about the user to any remote systems. The remote system determines a set of HRTFs that are customized to the user using, e.g., machine learning, and provides the customized set of HRTFs to the audio system 200.

The tracking module 260 is configured to track locations of one or more sound sources. The tracking module 260 may compare current DOA estimates and compare them with a stored history of previous DOA estimates. In some embodiments, the audio system 200 may recalculate DOA estimates on a periodic schedule, such as once per second, or once per millisecond. The tracking module may compare the current DOA estimates with previous DOA estimates, and in response to a change in a DOA estimate for a sound source, the tracking module 260 may determine that the sound source moved. In some embodiments, the tracking module 260 may detect a change in location based on visual information received from the headset or some other external source. The tracking module 260 may track the movement of one or more sound sources over time. The tracking module 260 may store values for a number of sound sources and a location of each sound source at each point in time. In response to a change in a value of the number or locations of the sound sources, the tracking module 260 may determine that a sound source moved. The tracking module 260 may calculate an estimate of the localization variance. The localization variance may be used as a confidence level for each determination of a change in movement.

The beamforming module 270 is configured to process one or more ATFs to selectively emphasize sounds from sound sources within a certain area while de-emphasizing sounds from other areas. In analyzing sounds detected by the sensor array 220, the beamforming module 270 may combine information from different acoustic sensors to emphasize sound associated from a particular region of the local area while deemphasizing sound that is from outside of the region. The beamforming module 270 may isolate an audio signal associated with sound from a particular sound source from other sound sources in the local area based on, e.g., different DOA estimates from the DOA estimation module 240 and the tracking module 260. The beamforming module 270 may thus selectively analyze discrete sound sources in the local area. In some embodiments, the beamforming module 270 may enhance a signal from a sound source. For example, the beamforming module 270 may apply sound filters which eliminate signals above, below, or between certain frequencies. Signal enhancement acts to enhance sounds associated with a given identified sound source relative to other sounds detected by the sensor array 220.

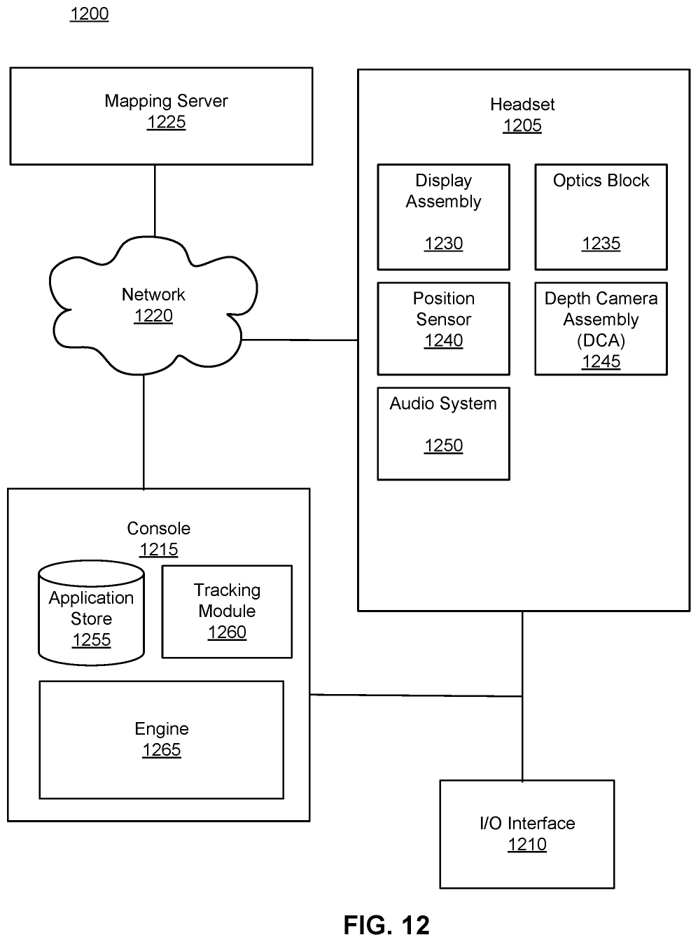

The sound filter module 280 determines sound filters for the transducer array 210. In some embodiments, the sound filters cause the audio content to be spatialized, such that the audio content appears to originate from a target region. The sound filter module 280 may use HRTFs and/or acoustic parameters to generate the sound filters. The acoustic parameters describe acoustic properties of the local area. The acoustic parameters may include, e.g., a reverberation time, a reverberation level, a room impulse response, etc. In some embodiments, the sound filter module 280 calculates one or more of the acoustic parameters. In some embodiments, the sound filter module 280 requests the acoustic parameters from a mapping server (e.g., as described below with regard to FIG. 12).

The sound filter module 280 provides the sound filters to the transducer array 210. In some embodiments, the sound filters may cause positive or negative amplification of sounds as a function of frequency. In some embodiments, the sound filter module 280 may generate sound filters for beamsteering. For example, the transducer array 210 may comprise multiple speaker packages, and the sound filter module 280 may generate sound filters such that the transducer array 210 steers output sound to an ear of a user.

FIG. 3 is an example of an isometric view of a transducer section 300 of a speaker package in a first position. The transducer section 300 may be a component for an embodiment of the transducer array 210 of FIG. 2. In the first position, a first side 316 of the transducer section 300 includes a first surface of piezoelectric actuators and a first surface of the frame 312 that are in or around a same plane. The piezoelectric actuators include piezoelectric actuators 314a, 314b, 314c, and 314d. A first pair of piezoelectric actuators includes first and second piezoelectric actuators 314a and 314b. Between 314a and 314b, there may be a tiny gap, which may be smaller than 1 μm. A second pair of piezoelectric actuators includes third and fourth piezoelectric actuators 314c and 314d. Each of the piezoelectric actuators have a width 380 that is larger than a length 370 of the piezoelectric actuators. The length 370 of the piezoelectric actuators 314a, 314b, 314c, 314d corresponds to a distance between a first end and a second end of the piezoelectric actuators 314a, 314b, 314c, 314d. The width 380 of the piezoelectric actuators corresponds to a distance across the second end of the piezoelectric actuators. The frame 312 includes a first section 312a and a second section 312b. The first section 312a is an external portion of the frame 312 that surrounds both pairs of the piezoelectric actuators. The second section 312b is an internal portion of the frame 312 which separates the first and second pairs of the piezoelectric actuators.

The piezoelectric actuators of the transducer section 300 have a high aspect ratio (e.g., width 380 to length 370 ratio). The length 370 of each piezoelectric actuator (e.g., 314a, 314b, 314c, and 314d) is relatively short compared to the width 380 of the piezoelectric actuator. A high aspect ratio of the piezoelectric actuators enables the speaker package to better fit in the form factor of the headset 100, which is constrained by size of the headset 100. A high aspect ratio of the piezoelectric actuators may also enable the resonance frequency of the piezoelectric actuator to be outside of a main band of human hearing (e.g., above 20 kHz). The piezoelectric actuators may have a resonance frequency above 20 kHz. Given a particular width 380, decreasing the length of the piezoelectric actuator can increase a frequency response of the piezoelectric actuators to improve active noise cancellation. Given a particular length 370, increasing the width 380 of the piezoelectric actuators enables the maximum displacement of the piezoelectric actuators to be distributed over a free end which allows operation within a constrained thickness more effectively. Increasing the width 380 of the piezoelectric actuators can enable maintaining a larger surface area in view of the short length 370 so that the piezoelectric actuators can move a relatively large volume of air for a given displacement, resulting in better performance in a constrained package.

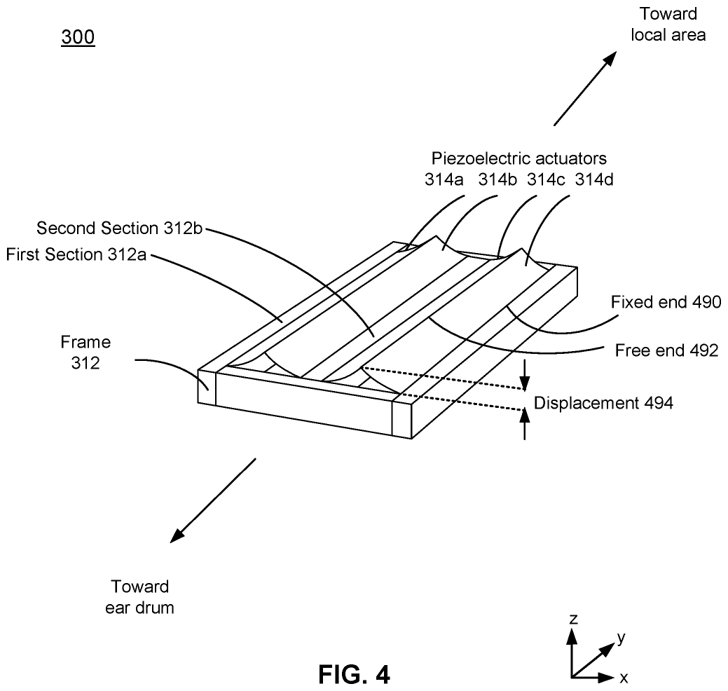

FIG. 4 is an example of an isometric view of the transducer section 300 of FIG. 3 with split piezoelectric actuators in a second position, in accordance with one or more embodiments. The piezoelectric actuators 314a, 314b, 314c, 314d each have a fixed end 490 (e.g., first end) and a free end 492 (e.g., second end) opposite the fixed end 490. In the second position, the free end 492 of the piezoelectric actuators is displaced in a direction towards a front volume section of a speaker package. The fixed ends 490 of the first and fourth piezoelectric actuators 314a and 314d are coupled to portions of the first section 312a of the frame 312, and the fixed ends 490 of the second and third piezoelectric actuators 314b and 314c are coupled to portions of the second section 312b of the frame 312. The free ends 492 of the first and second piezoelectric actuators 314a and 314b face each other. The free ends 492 of the third and fourth piezoelectric actuators 314c and 314d face each other. In the second position, a height of a free end (e.g., the free end 492 of the piezoelectric actuator 314d) of a piezoelectric actuator has a displacement 494 relative to a height of a fixed end of the piezoelectric actuator (e.g., the fixed end 490 of the piezoelectric actuator 314d).

As illustrated, the piezoelectric actuators 314a, 314b, 314c, 314d are all actuated to have their respective free ends displaced at a same amount relative to their corresponding fixed ends. In some embodiments, some or all of the piezoelectric actuators 314a, 314b, 314c, 314d may be actuated independently. Accordingly, an amount of displacement may vary as a function of time for different free ends. For example, at a same time value, an amount of displacement of the free end 492 of the piezoelectric actuator 314a may be different than an amount of displacement of the piezoelectric actuator 314b.

In some embodiments, the frame 312 may be made from a non-conductive material (e.g., plastic, glass, silicon). On top of the frame 312, there are some thin conductive traces and pads (copper, gold, aluminum, etc.) for electrical conduction. The thickness of these traces can be 10-1000 nm. A thickness of the frame 312 is greater than a thickness of the piezoelectric actuators 314. The thickness of the frame can be 100-600 μm.

The piezoelectric actuators are made of piezoelectric materials (e.g., piezoelectric ceramics) that can produce a physical displacement in response to an applied electric field. The piezoelectric material may be aluminum nitride (AlN), scandium doped aluminum nitride (AlScN), zinc oxide (ZnO), lead zirconate titanate (PZT), etc. In some embodiments, the piezoelectric actuators are made of AlN or AlScN, and the transducer section 300 does not require a direct current (DC) voltage bias to drive the piezoelectric actuators, which can simplify a corresponding electronic circuit for activating the piezoelectric actuators. The low material loss of the AlN or AlScN can improve power efficiency of the transducer section 300.

The piezoelectric actuators may be bimorphs, cantilevers that include two layers of piezoelectric materials. When a voltage is applied to drive or activate the bimorph, the applied voltage causes a first piezoelectric layer to expand (e.g., push) and a second piezoelectric layer to contract (e.g., pull), causing the cantilever to extend further than it normally would in comparison to a cantilever with a single layer of piezoelectric material. Use of a bimorph as piezoelectric actuators enables larger volume displacement. The thicknesses of the first and second piezoelectric layers of the bimorph can be the same for increased performance. The total thickness of the bimorph can be 0.5-4 μm. The two layers of the piezoelectric material may be sandwiched by three thin electrodes, which can be platinum (Pt) or molybdenum (Mo). The metal-piezo-metal-piezo-metal stack forms the bimorph. The metal layers are connected electrically through the traces to the pads on the frame 312 for electrical connection. For the ease of manufacturing, this actuator can also be a unimorph, cantilevers that include one layer of piezoelectric material and one passive structure layer (such as silicon). The bimorph design has at least 3 dB in efficiency over a unimorph design, but the bimorph may be more challenging to manufacture.

Electrodes may be formed to contact the piezoelectric actuators so that the piezoelectric actuators can be driven by an applied voltage. The pads may be placed on top of the frame 312, and they may be connected through thin traces connecting to the metal layers on the bimorphs. A controller may apply a voltage from a power supply to the piezoelectric actuators via the electrodes to activate the piezoelectric actuators.

Having multiple piezoelectric actuators (e.g., 314a, 314b, 314c, 314d) in the transducer section 310 allows for an increase in an actuator area, which increases the volume displacement of air for better performance of the speaker package. The four piezoelectric actuators move together (in phase) to generate the acoustic pressure wave. In other embodiments, there could be a different number of piezoelectric actuators.

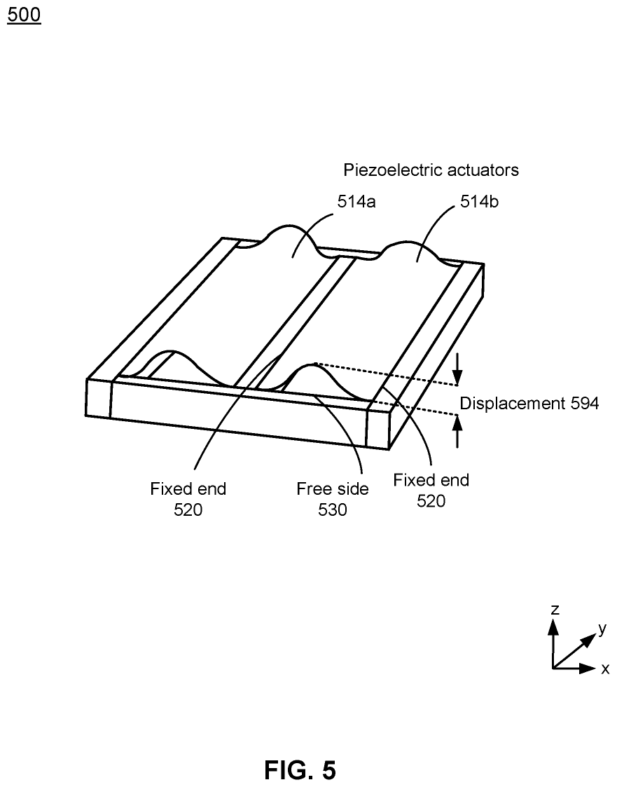

FIG. 5 is an example of an isometric view of a transducer section 500 with continuous actuators displaced, in accordance with one or more embodiments. The transducer section 500 may be a component for an embodiment of the transducer array 210 of FIG. 2. The transducer section 500 is similar to the transducer section 300 of FIGS. 3-4 except that each piezoelectric actuator 514a, 514b has two fixed ends. Because both ends of the piezoelectric actuators 514a and 514b are clamped, displacement occurs in a central portion of the piezoelectric actuators 514a and 514b which is allowed to move, as opposed to the clamped ends of 514a and 514b. Each of the piezoelectric actuators 514a and 514b has two free sides. For example, piezoelectric actuator 514a has two fixed ends 520 and two free sides 530. The piezoelectric actuators 514a and 514b move together (in phase) to generate the acoustic pressure wave. In other embodiments, there could be a different number of piezoelectric actuators 514. In some embodiments, some or all of the piezoelectric actuators 514a and 514b may be actuated independently. Accordingly, an amount of displacement may vary as a function of time for different free sides. For example, at a same time value, an amount of displacement of the free sides 530 of the piezoelectric actuator 514a may be different than an amount of displacement of the piezoelectric actuator 514b. Also, for example, at a same time value, an amount of displacement of the free sides 530 of the piezoelectric actuator 514a may be different than an amount of displacement of the piezoelectric actuator 514a.

In the second position, a height of the free side (e.g., the free side 530 of the piezoelectric actuator 514b) of a piezoelectric actuator has a displacement 594 relative to a height of a fixed end of the piezoelectric actuator (e.g., the fixed end 520 of piezoelectric actuator 514b).

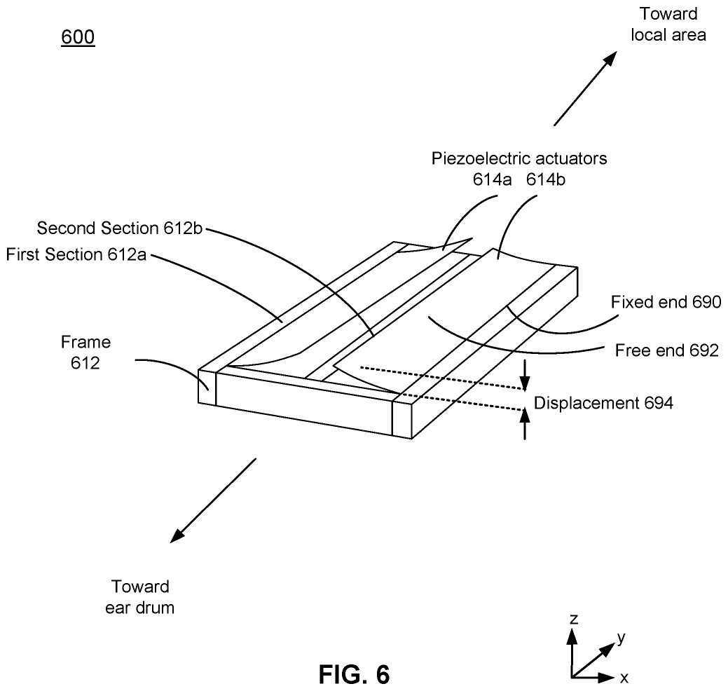

FIG. 6 is an example of an isometric view of a transducer section 600 with actuators having a fixed end 690 and a free end 692, in accordance with one or more embodiments. The transducer section 600 may be a component for an embodiment of the transducer array 210 of FIG. 2. The transducer section 600 is similar to the transducer section 300 of FIG. 3, except each piezoelectric actuator 614a, 614b may comprise a fixed end 690 coupled to a first section 612a and a free end 692 located adjacent to a second section 612b of the frame 612. The free end 692 may be located toward the center of the frame 612, and the fixed end 690 may be located toward the outer portion of the frame, e.g., first section 612. The displacement 694 may be measured as a height between the free end 690 and the frame 112.

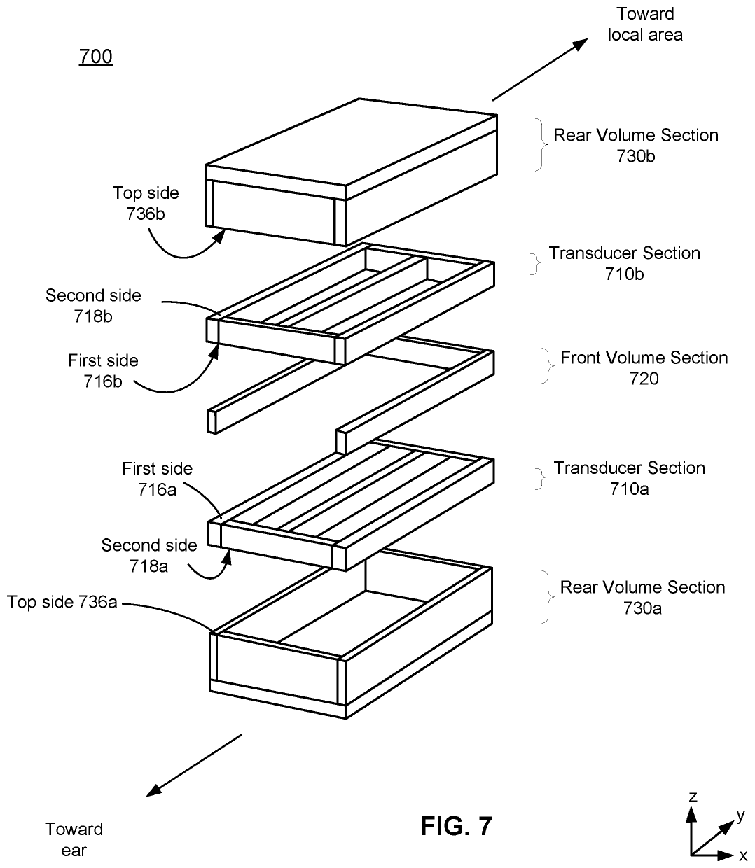

FIG. 7 is an example of an exploded view of a speaker package 700 having two transducer sections, in accordance with one or more embodiments. The speaker package may be a component for an embodiment of the transducer array 210 of FIG. 2. The speaker package 700 includes a first transducer section 710a, a second transducer section 710b, a front volume section 720, a first rear volume section 730a, and a second rear volume section 730b.

The front volume section 720 may be located between the first transducer section 701a and the second transducer section 710b. The first transducer sections 710a and 710b may be the same as the transducer section described with respect to FIG. 3. In some embodiments, the transducer sections 710a, 710b may be the same as the transducer sections 500 or 600 of FIGS. 5-6. A side of the front volume section 720 is attached to a first side 716a of a first transducer section 710a, and an opposite side of the front volume section 720 is attached to a first side 716b of the second transducer section 710b to generate a front cavity. A second side 718a of first transducer section 710a is coupled to a top side 736a of the rear volume section 730a to generate a first rear cavity. A second side 718b of second transducer section 710b is coupled to the top side 736b of the rear volume section 730b to generate a second rear cavity.

The piezoelectric actuators in the transducer sections 710 are shown in a first position similar to the first position for the transducer section 300 of FIG. 3. When the transducer sections 710 are in a second position, a free end of the piezoelectric actuators are displaced in a direction towards the front volume section 720 of the speaker package 700.

Once the piezoelectric actuators of the first and second transducer sections 710a and 710b are activated, the piezoelectric actuators push air against the front volume section 720 and first and second rear volume sections 730a and 730b of the speaker package 700. A first acoustic pressure wave may be produced by the first transducer section 710a, and a second acoustic pressure wave may be produced by the second transducer section 710b. In some embodiments, each of the piezoelectric actuators of the first transducer section 710a and/or the second transducer section 710b may be actuated independent from one another. For example, a single piezoelectric actuator of the first transducer section 710a may be actuated while the remaining piezoelectric actuators of the first transducer section 710a and the second transducer section 710b are not actuated. In some embodiments, the piezoelectric actuators of the first and second transducer sections 710a and 710b may move together (in phase) to generate the acoustic pressure wave (e.g., the first and second acoustic pressure wave). The audio (acoustic pressure wave) produced from the transducer section 710a exits the speaker package 700 through the aperture in the front volume section 720 to provide sound to a user via an ear canal of the user. The rear volume sections 730a and 730b may be used to attenuate an out-of-phase acoustic pressure wave that is produced by the first and second transducer sections 710a and 710b. The front volume section 720 and the first and second rear volume sections 730a and 730b may be selected to increase or maximize the energy transduction efficiency and sound pressure level output. This embodiment with two transducer sections will double the acoustic output while sharing the same front cavity, compared to the embodiment with a single transducer section.

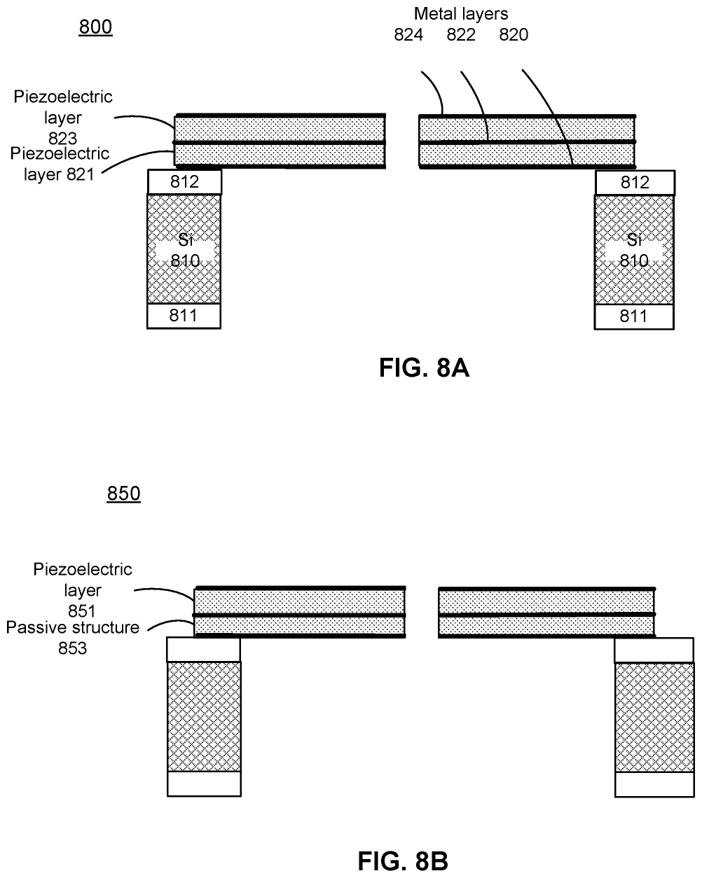

FIG. 8A is an example of a cross sectional view of a transducer section 800 with two piezoelectric layers, in accordance with one or more embodiments. The transducer section 800 may comprise a substrate made of a silicon (Si) wafer 810 and silicon oxide (SiO₂) layers 811 and 812. A first silicon oxide layer 811 is on one side (e.g., backside) of the silicon wafer 810, and a second silicon oxide layer 812 may be located on an opposite side (e.g., frontside) of the silicon wafer 810.

The transducer section 800 may comprise a first metal layer 820, a first piezoelectric layer 821, a second metal layer 822, a second piezoelectric layer 823, and a third metal layer 824 on the second silicon oxide layer 812 (e.g., front side of the substrate). The metal layers 820, 822, 824 may be made of platinum (Pt) or molybdenum (Mo) material, and the piezoelectric layers 821 and 823 may be made aluminum nitride (AlN) material. A first metal layer 820 is deposited/patterned on the second silicon oxide layer 812.

To generate an acoustic pressure wave, a voltage may be applied to one or both piezoelectric layers 821, 823 which causes the piezoelectric layers 821, 823 to expand or contract relative to each other. The difference in relative expansion will cause the piezoelectric layers 821, 823 to curve, resulting in a volume displacement. Oscillation in the amount of curvature may generate acoustic pressure waves.

The transducer section 850 shown in FIG. 8B is similar to the transducer section 800 shown in FIG. 8A, with the exception that, instead of having two piezoelectric layers, the transducer section 850 comprises a piezoelectric layer 851 and a passive structure 853. To generate an acoustic wave, a voltage may be applied to the piezoelectric layer 851, which causes the piezoelectric layer 851 to contract relative to the passive structure 853, thereby causing the piezoelectric layer 823 and the passive structure 821 to curve, resulting in a volume displacement.

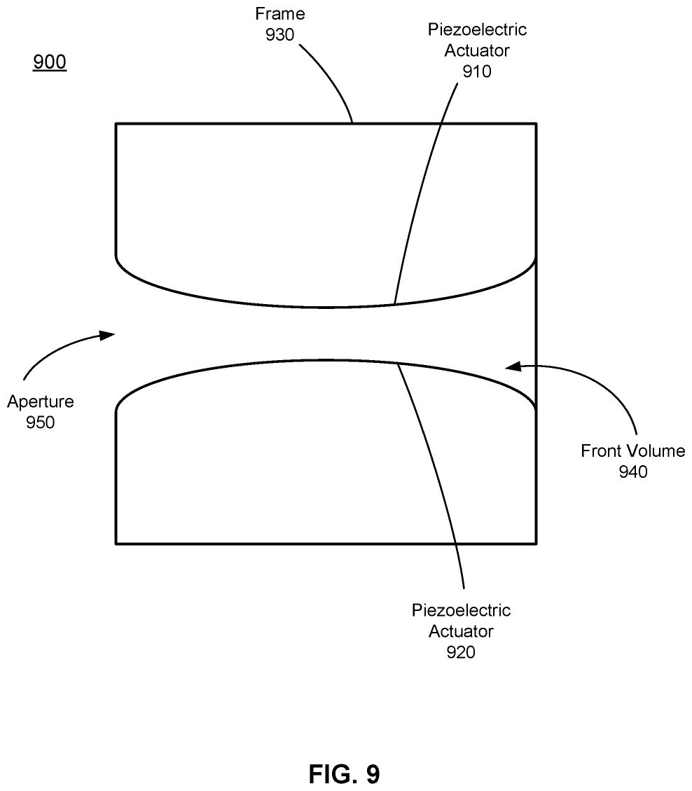

FIG. 9 is an example of a cross sectional view of a speaker package 900 with two transducer sections, in accordance with one or more embodiments. The speaker package 900 comprises a first piezoelectric actuator 910 in a first transducer section and a second piezoelectric actuator 920 in a second transducer section coupled to a frame 930. The piezoelectric actuators 910 are illustrated in a displaced position toward a front volume 940 of the speaker package 900. The displacement into the front volume 940 forces a pressure wave to exit the speaker package 900 out of an aperture 950 in the frame 940.

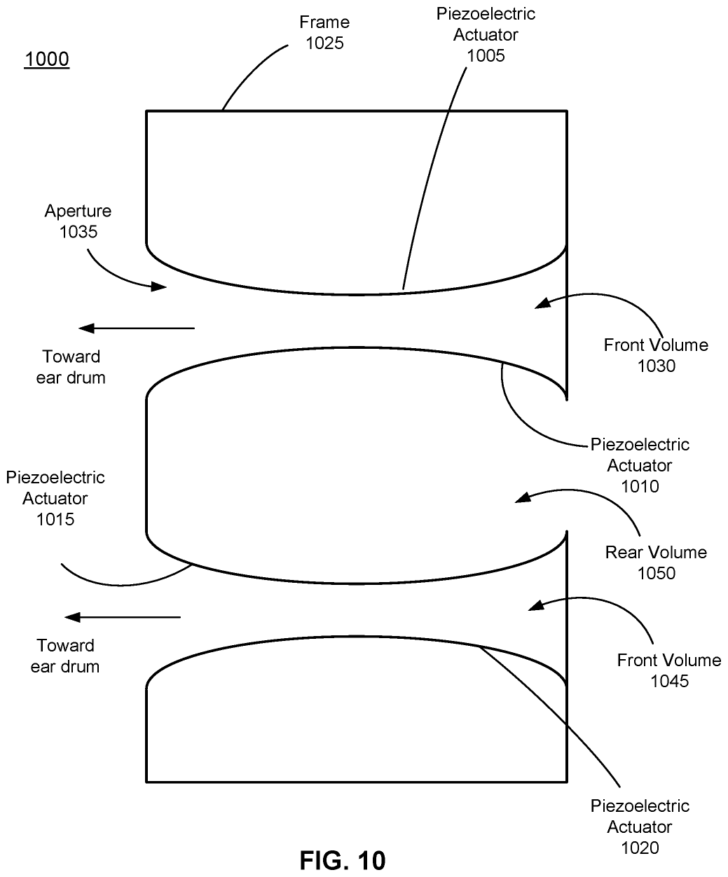

FIG. 10 is an example of a cross sectional view of a speaker package 1000 with four transducer sections, in accordance with one or more embodiments. The speaker package 1000 comprises a first piezoelectric actuator 1005 in a first transducer section, a second piezoelectric actuator 1010 in a second transducer section, a third piezo electric actuator 1015 in a third transducer section, and a fourth piezoelectric actuator 1020 in a fourth transducer section, each coupled to a frame 1025.

The first piezoelectric actuator 1010 and the second piezoelectric actuator 1020 are illustrated displaced into a common first front volume 1030. The air displaced by the first piezoelectric actuator 1005 and the second piezoelectric actuator 1010 exits an aperture 1035 in the frame 1025 as sound waves directed toward the ear of the user.

The third piezoelectric actuator 1015 and the fourth piezoelectric actuator 1020 are illustrated displaced into a common second front volume 1045. The air displaced by the third piezoelectric actuator 1015 and the fourth piezoelectric actuator 1020 exits an aperture 1050 in the frame 1040 as sound waves directed toward the ear of the user.

The speaker package 1000 comprises a rear volume 1050 located between the second piezoelectric actuator 1010 and the third piezoelectric actuator 1015. The acoustic pressure waves generated by the second piezoelectric actuator 1010 and the third piezoelectric actuator 1015 in the rear volume 1050 may exit though an aperture 1055 in the frame 1040. The aperture 1055 may direct the acoustic pressure waves away from the ear of the user. In the far field, the acoustic pressure waves exiting the aperture 1055 may cancel the acoustic pressure waves exiting the apertures 1035, 1050, thereby cancelling the sound in the far field. In other embodiments, speaker packages may comprise any suitable number of transducer layers, such as 6, 8, or any other number of transducer layers.

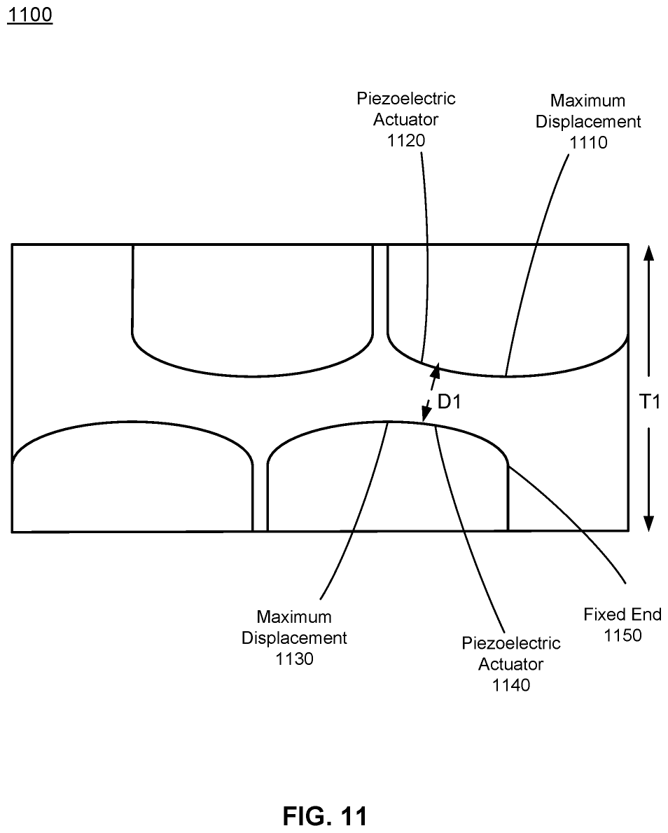

FIG. 11 is an example of a cross sectional view of a speaker package 1100 with offset piezoelectric layers, in accordance with one or more embodiments. The minimum thickness of a speaker package may be limited by a minimum distance between piezoelectric actuators in adjacent transducer layers. The minimum distance between piezoelectric actuators may be selected to prevent contact between piezoelectric actuators, prevent electromagnetic interference between piezoelectric actuators, or for any other suitable purpose. As illustrated in FIG. 11, a point of maximum displacement 1110 of a piezoelectric actuator 1120 in a first transducer layer is not aligned with a point of maximum displacement 1130 of a piezoelectric actuator 1140 in a second layer. In some embodiments, the point of maximum displacement 1110 of the piezoelectric actuator 1120 may be aligned with a fixed end 1150 of the piezoelectric actuator 1140. By offsetting the piezoelectric actuators 1120, 1140, the thickness T1 of the speaker package 1100 may be decreased while maintaining a minimum distance D1 between the piezoelectric actuators 1120, 1140. The piezoelectrect actuators 1120, 1140 may displace acoustic pressure waves out of the speaker package 1100 in a direction out of the page toward an ear of a user.

FIG. 12 is a system 1200 that includes a headset 1205, in accordance with one or more embodiments. In some embodiments, the headset 1205 may be the headset 100 of FIG. 1A or the headset 105 of FIG. 1B. The system 1200 may operate in an artificial reality environment (e.g., a virtual reality environment, an augmented reality environment, a mixed reality environment, or some combination thereof). The system 1200 shown by FIG. 12 includes the headset 1205, an input/output (I/O) interface 1210 that is coupled to a console 1215, the network 1220, and the mapping server 1225. While FIG. 12 shows an example system 1200 including one headset 1205 and one I/O interface 1210, in other embodiments any number of these components may be included in the system 1200. For example, there may be multiple headsets each having an associated I/O interface 1210, with each headset and I/O interface 1210 communicating with the console 1215. In alternative configurations, different and/or additional components may be included in the system 1200. Additionally, functionality described in conjunction with one or more of the components shown in FIG. 12 may be distributed among the components in a different manner than described in conjunction with FIG. 12 in some embodiments. For example, some or all of the functionality of the console 1215 may be provided by the headset 1205.

The headset 1205 includes the display assembly 1230, an optics block 1235, one or more position sensors 1240, and the DCA 1245. Some embodiments of headset 1205 have different components than those described in conjunction with FIG. 12. Additionally, the functionality provided by various components described in conjunction with FIG. 12 may be differently distributed among the components of the headset 1205 in other embodiments, or be captured in separate assemblies remote from the headset 1205.

The display assembly 1230 displays content to the user in accordance with data received from the console 1215. The display assembly 1230 displays the content using one or more display elements (e.g., the display elements 120). A display element may be, e.g., an electronic display. In various embodiments, the display assembly 1230 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 1235.

The optics block 1235 may magnify image light received from the electronic display, corrects optical errors associated with the image light, and presents the corrected image light to one or both eyeboxes of the headset 1205. In various embodiments, the optics block 1235 includes one or more optical elements. Example optical elements included in the optics block 1235 include: an aperture, a Fresnel lens, a convex lens, a concave lens, a filter, a reflecting surface, or any other suitable optical element that affects image light. Moreover, the optics block 1235 may include combinations of different optical elements. In some embodiments, one or more of the optical elements in the optics block 1235 may have one or more coatings, such as partially reflective or anti-reflective coatings.

Magnification and focusing of the image light by the optics block 1235 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 1235 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 1235 corrects the distortion when it receives image light from the electronic display generated based on the content.

The position sensor 1240 is an electronic device that generates data indicating a position of the headset 1205. The position sensor 1240 generates one or more measurement signals in response to motion of the headset 1205. The position sensor 190 is an embodiment of the position sensor 1240. Examples of a position sensor 1240 include: one or more IMUs, one or more accelerometers, one or more gyroscopes, one or more magnetometers, another suitable type of sensor that detects motion, or some combination thereof. The position sensor 1240 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 1205 from the sampled data. For example, the IMU integrates the measurement signals received from the accelerometers over time to estimate a velocity vector and integrates the velocity vector over time to determine an estimated position of a reference point on the headset 1205. The reference point is a point that may be used to describe the position of the headset 1205. While the reference point may generally be defined as a point in space, however, in practice the reference point is defined as a point within the headset 1205.

The DCA 1245 generates depth information for a portion of the local area. The DCA includes one or more imaging devices and a DCA controller. The DCA 1245 may also include an illuminator. Operation and structure of the DCA 1245 is described above with regard to FIG. 1A.

The audio system 1250 provides audio content to a user of the headset 1205. The audio system 1250 is substantially the same as the audio system 200 describe above. The audio system 1250 may comprise one or acoustic sensors, one or more transducers, and an audio controller. The audio system 1250 may provide spatialized audio content to the user. In some embodiments, the audio system 1250 may request acoustic parameters from the mapping server 1225 over the network 1220. The acoustic parameters describe one or more acoustic properties (e.g., room impulse response, a reverberation time, a reverberation level, etc.) of the local area. The audio system 1250 may provide information describing at least a portion of the local area from e.g., the DCA 1245 and/or location information for the headset 1205 from the position sensor 1240. The audio system 1250 may generate one or more sound filters using one or more of the acoustic parameters received from the mapping server 1225, and use the sound filters to provide audio content to the user.

The audio system 1250 may comprise one or more speaker packages. Each speaker package may comprise multiple piezoelectric actuators. Each speaker package may be integrated into a portion of the headset 1205. For example, the speaker package may each be positioned within a temple arm of the headset 1205.

The I/O interface 1210 is a device that allows a user to send action requests and receive responses from the console 1215. An action request is a request to perform a particular action. For example, an action request may be an instruction to start or end capture of image or video data, or an instruction to perform a particular action within an application. The I/O interface 1210 may include one or more input devices. Example input devices include: a keyboard, a mouse, a game controller, or any other suitable device for receiving action requests and communicating the action requests to the console 1215. An action request received by the I/O interface 1210 is communicated to the console 1215, which performs an action corresponding to the action request. In some embodiments, the I/O interface 1210 includes an IMU that captures calibration data indicating an estimated position of the I/O interface 1210 relative to an initial position of the I/O interface 1210. In some embodiments, the I/O interface 1210 may provide haptic feedback to the user in accordance with instructions received from the console 1215. For example, haptic feedback is provided when an action request is received, or the console 1215 communicates instructions to the I/O interface 1210 causing the I/O interface 1210 to generate haptic feedback when the console 1215 performs an action.

The console 1215 provides content to the headset 1205 for processing in accordance with information received from one or more of: the DCA 1245, the headset 1205, and the I/O interface 1210. In the example shown in FIG. 12, the console 1215 includes an application store 1255, a tracking module 1260, and an engine 1265. Some embodiments of the console 1215 have different modules or components than those described in conjunction with FIG. 12. Similarly, the functions further described below may be distributed among components of the console 1215 in a different manner than described in conjunction with FIG. 12. In some embodiments, the functionality discussed herein with respect to the console 1215 may be implemented in the headset 1205, or a remote system.

The application store 1255 stores one or more applications for execution by the console 1215. An application is a group of instructions, that when executed by a processor, generates content for presentation to the user. Content generated by an application may be in response to inputs received from the user via movement of the headset 1205 or the I/O interface 1210. Examples of applications include: gaming applications, conferencing applications, video playback applications, or other suitable applications.

The tracking module 1260 tracks movements of the headset 1205 or of the I/O interface 1210 using information from the DCA 1245, the one or more position sensors 1240, or some combination thereof. For example, the tracking module 1260 determines a position of a reference point of the headset 1205 in a mapping of a local area based on information from the headset 1205. The tracking module 1260 may also determine positions of an object or virtual object. Additionally, in some embodiments, the tracking module 1260 may use portions of data indicating a position of the headset 1205 from the position sensor 1240 as well as representations of the local area from the DCA 1245 to predict a future location of the headset 1205. The tracking module 1260 provides the estimated or predicted future position of the headset 1205 or the I/O interface 1210 to the engine 1265.

The engine 1265 executes applications and receives position information, acceleration information, velocity information, predicted future positions, or some combination thereof, of the headset 1205 from the tracking module 1260. Based on the received information, the engine 1265 determines content to provide to the headset 1205 for presentation to the user. For example, if the received information indicates that the user has looked to the left, the engine 1265 generates content for the headset 1205 that mirrors the user's movement in a virtual local area or in a local area augmenting the local area with additional content. Additionally, the engine 1265 performs an action within an application executing on the console 1215 in response to an action request received from the I/O interface 1210 and provides feedback to the user that the action was performed. The provided feedback may be visual or audible feedback via the headset 1205 or haptic feedback via the I/O interface 1210.

The network 1220 couples the headset 1205 and/or the console 1215 to the mapping server 1225. The network 1220 may include any combination of local area and/or wide area networks using both wireless and/or wired communication systems. For example, the network 1220 may include the Internet, as well as mobile telephone networks. In one embodiment, the network 1220 uses standard communications technologies and/or protocols. Hence, the network 1220 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 1220 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 1220 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 1225 may include a database that stores a virtual model describing a plurality of spaces, wherein one location in the virtual model corresponds to a current configuration of a local area of the headset 1205. The mapping server 1225 receives, from the headset 1205 via the network 1220, information describing at least a portion of the local area and/or location information for the local area. The user may adjust privacy settings to allow or prevent the headset 1205 from transmitting information to the mapping server 1225. The mapping server 1225 determines, based on the received information and/or location information, a location in the virtual model that is associated with the local area of the headset 1205. The mapping server 1225 determines (e.g., retrieves) one or more acoustic parameters associated with the local area, based in part on the determined location in the virtual model and any acoustic parameters associated with the determined location. The mapping server 1225 may transmit the location of the local area and any values of acoustic parameters associated with the local area to the headset 1205.

One or more components of system 1200 may contain a privacy module that stores one or more privacy settings for user data elements. The user data elements describe the user or the headset 1205. For example, the user data elements may describe a physical characteristic of the user, an action performed by the user, a location of the user of the headset 1205, a location of the headset 1205, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 1200 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A dipole speaker assembly comprising:
a first transducer section including a frame and a first piezoelectric actuator coupled to the frame;
a second transducer section including a second frame and a second piezoelectric actuator coupled to the second frame;
a front volume section positioned between the first transducer section and the second transducer section to form a front cavity from which a generated acoustic pressure wave exits the front volume section towards an ear canal of a user; and
a first rear volume section coupled to the first transducer section and a second rear volume section coupled to the second transducer section, from which the generated acoustic pressure wave exits the rear volume sections away from the ear canal of the user.

2. The dipole speaker assembly of claim 1, further comprising:
a third transducer section coupled to the first rear volume section;
a second front volume section coupled to the third transducer section; and
a fourth transducer section coupled to the second front volume section.

3. The dipole speaker assembly of claim 1, wherein the acoustic pressure wave exiting the rear volume sections is configured to cancel the acoustic pressure wave exiting the front volume section in a far field.

4. The dipole speaker assembly of claim 1, wherein each of the piezoelectric actuators includes a first end and a second end opposite the first end, the first end being attached to the frame, wherein a length of the piezoelectric actuators corresponds to a distance between the first end and the second end, a width of the piezoelectric actuators corresponds to a distance across the second end in a dimension in-line with the ear canal, the width being larger than the length.

5. The dipole speaker assembly of claim 1, wherein the first transducer section includes a first pair of piezoelectric actuators and a second pair of the piezoelectric actuators.

6. The dipole speaker assembly of claim 1, wherein each of the piezoelectric actuators comprise a fixed end and a free end opposite the fixed end.

7. The dipole speaker assembly of claim 1, wherein each of the piezoelectric actuators comprises a first fixed end and a second fixed end opposite the first fixed end.

8. The dipole speaker assembly of claim 1, wherein the first piezoelectric actuators is a bimorph comprising a first piezoelectric layer and a second piezoelectric layer, the first piezoelectric layer configured to expand and the second piezoelectric layer configured to contract responsive to a voltage being applied to the bimorph.

9. A headset comprising:
a front portion comprising a display element;
a temple section coupled to the front portion; and
a speaker package located within the temple section, wherein the speaker package comprises:
a first transducer section including a frame and a first piezoelectric actuator coupled to the frame;
a second transducer section including a second frame and a second piezoelectric actuator coupled to the second frame;
a front volume section positioned between the first transducer section and the second transducer section to form a front cavity from which a generated acoustic pressure wave exits the front volume section towards an ear canal of a user; and
a first rear volume section coupled to the first transducer section and a second rear volume section coupled to the second transducer section, from which the generated acoustic pressure wave exits the rear volume sections away from the ear canal of the user.

10. The headset of claim 9, wherein the speaker package further comprises:
a third transducer section coupled to the first rear volume section;
a second front volume section coupled to the third transducer section; and
a fourth transducer section coupled to the second front volume section.

11. The headset of claim 9, wherein the acoustic pressure wave exiting the rear volume sections is configured to cancel the acoustic pressure wave exiting the front volume section in a far field.

12. The headset of claim 9, wherein each of the piezoelectric actuators includes a first end and a second end opposite the first end, the first end being attached to the frame, wherein a length of the piezoelectric actuators corresponds to a distance between the first end and the second end, a width of the piezoelectric actuators corresponds to a distance across the second end in a dimension in-line with the ear canal, the width being larger than the length.

13. The headset of claim 9, wherein the first transducer section includes a first pair of piezoelectric actuators and a second pair of the piezoelectric actuators.

14. The headset of claim 9, wherein each of the piezoelectric actuators comprise a fixed end and a free end opposite the fixed end.

15. The headset of claim 9, wherein each of the piezoelectric actuators comprises a first fixed end and a second fixed end opposite the first fixed end.

16. The headset of claim 9, wherein the first piezoelectric actuator is a bimorph comprising a first piezoelectric layer and a second piezoelectric layer, the first piezoelectric layer configured to expand and the second piezoelectric layer configured to contract responsive to a voltage being applied to the bimorph.

17. The headset of claim 9, wherein the first piezoelectric actuator is a unimorph comprising a first piezoelectric layer and a passive structure layer.

18. The headset of claim 9, wherein the headset is configured to beamsteer audio content to an ear of a user using a plurality of speaker packages located within the temple section.

19. The headset of claim 9, wherein the speaker package forms a portion of a surface of the temple section.

20. The headset of claim 9, wherein the first piezoelectric actuator is offset from the second piezoelectric actuator.
